(19) United States
(12) Patent Application Publication
(10) Pub. No.: US 2023/0053783 A1
(43) Pub. Date: Feb. 23, 2023

(54) Accessory for Wheelbarrows Method of Use

(71) Applicant: Oliver Hall, Washington DC, DC (US)

(72) Inventor: Oliver Hall, Washington DC, DC (US)

(21) Appl. No.: 17/404,195

(22) Filed: Aug. 17, 2021

(51) Int. Cl. B62B 1/20

(52) U.S. Cl. CPC B62B 1/204

(57) ABSTRACT

The present invention is directed to accessory item for wheelbarrows. The device is positionable between the handles of wheelbarrows of virtually any design. The flexibility of the device allows for containing items of any irregular shape, the device containing a closure to ensure containment of the stored items. Adjustable attachment straps allow for adjusting the device to fit, while also ensuring that the device does not hang to far from the wheelbarrow handles so as to interfere with normal operation of the wheelbarrow.

### 1. FIELD OF THE INVENTION

The present invention relates generally to wheelbarrows. More particularly, the invention relates to an accessory device for wheelbarrows which allows for temporarily storing items.

### BACKGROUND OF THE INVENTION

Wheelbarrows have been used for many years as an easy way to manually transport, e.g., construction materials, over short distances. A common problem with the use of wheelbarrows is the need to carry items while using the device. As the wheelbarrow has only an open bed to position items there is usually no storage area. Transporting small tools and personal belongings like cell phones, keys, water bottles, etc, while being able to fully use the wheelbarrow, including emptying, traveling over rough terrain and dealing with inclement weather can be problematic. Users now have to either carry items on their person, or make additional and unnecessary trips back and forth between, e.g., a project zone and a storage zone.

There have been attempts in the prior art to solve the storage problem with wheelbarrows but all suffer from at least one of several drawbacks. First, the storage device may be rigid and difficult to manipulate. The rigid storage devices also cannot be collapsed for storage when not in use. The rigid devices also can limit maneuverability of the wheelbarrow and may not be attachable to every wheelbarrow. Also, prior art devices can block the bed of the wheelbarrow, which can be impractical depending upon the load to be carried. Additionally, prior art devices typically cannot contain items when tipping and rolling the wheelbarrow. Finally, prior art devices tend to be weathered easily and so must be carefully stored.

### SUMMARY OF THE INVENTION

The present invention is directed to an accessory item for wheelbarrows. The device is positionable between the handles of wheelbarrows of virtually any design. The flexibility of the device allows for containing items of any irregular shape, the device containing a closure to ensure containment of the stored items. Adjustable attachment straps allow for adjusting the device to fit, while also ensuring that the device does not hang to far from the wheelbarrow handles so as to interfere with normal operation of the wheelbarrow.

It is a major object of the invention to provide an improved accessory device for wheelbarrows for storing items.

It is another object of the invention to provide an improved accessory storage device for wheelbarrows that can be adjusted to attach to any style or size of wheelbarrow.

It is another object of the invention to provide an improved accessory storage device for wheelbarrows that is flexible.

It is another object of the invention to provide an improved accessory storage device for wheelbarrows that allows for uninhibited operation of the wheelbarrow.

It is another object of the invention to provide an improved accessory storage device for wheelbarrows that has a closure to contain items.

It is another object of the invention to provide an improved accessory storage device for wheelbarrows that is weatherproof.

It is another object of the invention to provide an improved accessory storage device for wheelbarrows that can be compacted for easy storage and transport.

It is another object of the invention to provide an improved accessory storage device for wheelbarrows that can be positioned between the wheelbarrow handles.

### BRIEF DESCRIPTION OF THE DRAWINGS

FIG. 1 shows a perspective view of the accessory storage device for wheelbarrows attached to a wheelbarrow.

FIG. 2 shows a top view of the of the accessory storage device for wheelbarrows.

### DETAILED DESCRIPTION

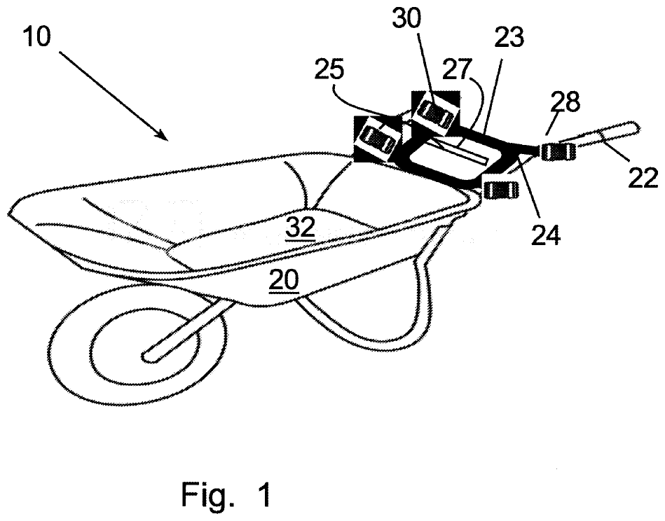

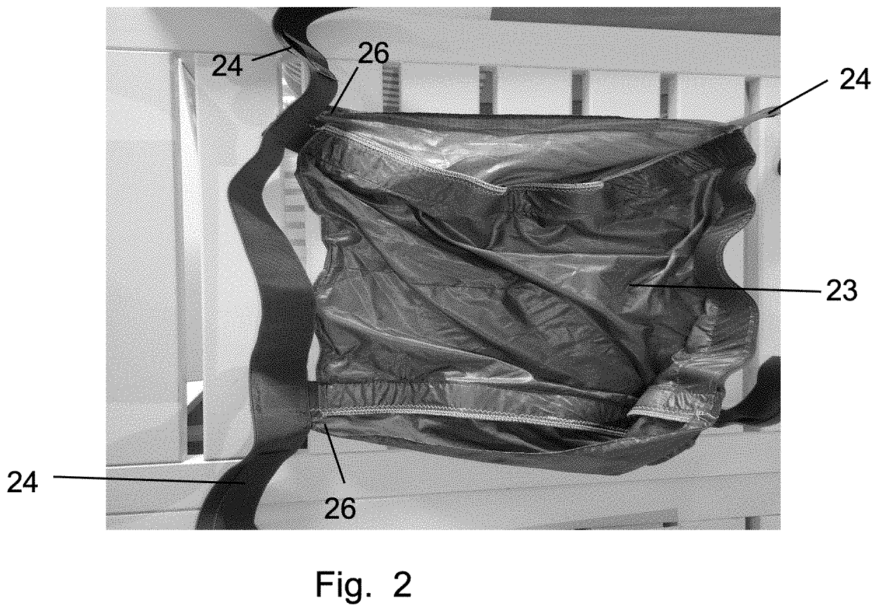

The present invention is directed to an accessory storage device for wheelbarrows and method of use, the device generally indicated by the numeral 10. Referring now to FIGS. 1 and 2, the device 10 is intended for use with wheelbarrows 20 of any size or shape provided they have a pair of spaced, elongated handles 22, as is generally required to manage and transport a load. It can be seen that the device 10 is a flexible bag type enclosure 23 having four spaced attachment straps 24 extending from the four corners 26 of the generally rectangular enclosure 10. Of course, the enclosure 23 may be any shape but should be sized to fit between the handles of a standard wheelbarrow and thus should be no more than about 2 feet in any dimension. Each strap has a connecting end 28, which can be adjusted to capture and firmly attach to the handles 22 of the wheelbarrow 20. Each strap 24 also includes a loop and buckle 30 or other sliding adjustment means for adjusting the length of the strap 24 in the well known manner. Thus, the device can be adjustably positioned between the handles 22 of the wheelbarrow 20. By adjusting the length of straps 24, the user can ensure that the device 10 is suspended between the handles 22 and does not sag so as to interfere with the normal operation of the wheelbarrow 20. It can be appreciated that suspending the device 10 between the handles in a fixed position relative to (adjacent) the bed 32 of the wheelbarrow 20 prevents the stored items from covering the bed 32 and interfering with the loading and unloading of the wheelbarrow. Also, the stored items in the device 10 can be accessed without disturbing the load.

The enclosure 23 itself is made from a durable, waterproof material such as a synthetic waterproof material. This allows for items to be stored for an extended period of time without getting damp or otherwise being effected by the elements. Also, a durable waterproof, weatherproof material will allow the device 10 to be stored outdoors with the wheelbarrow 20 for extended periods of time. The enclosure 23 has overlapping sections 29 (NEED DRAWING) which fold over the opening 25 to help contain the items positioned therein. The enclosure opening 25 may optionally include a fastening means 27 such as a zipper or the like to secure items once inside. In use, the enclosure 23 is positioned with the opening 25 facing upward.

When not in use, the device 10 can be folded or compacted for convenient storage. Preferably, when compacted the device 10 is small enough to fit in a small space such as the glove compartment of a vehicle.

In use, the user attaches the device 10 using straps 24 to connect to handles 22. Items may be positioned within the enclosure 23 via opening 25 and will be secured therein by overlapping panels 29 so that the user is not burdened with the task of zipping or unfastening to get access to the items. Care should be taken to ensure that the device 10 does not sag when attached. It can be appreciated that if the device 10 sags too much it will be close to or touching the ground which could interfere with operation of the wheelbarrow 20. An optimal height can be determined by the user but the bottom of the enclosure 23 should not be more than a foot below the handles 22 as it might come into contact with the legs of the user possibly impeding his progress. In accordance with the method of the invention, the user may adjust the straps 24 if weight from the contained items causes an undue amount of sag. To add or remove items from the device 10, the enclosure may be opened and resealed.

I claim:

1. An accessory storage device for a wheelbarrow having opposing, elongated handles and a load bed comprising:
a flexible main body having a plurality of attachment straps attached thereto;
each of said attachment straps attached to an edge of said device and including a loop for adjustably attaching about one of said handles;
wherein said device is suspended between said handles adjacent said bed.

2. The device of claim 1 wherein said flexible main body has an opening.

3. The device of claim 1 wherein said main body is made from a waterproof material.

4. The device of claim 2 wherein said opening is secured by a fastener.

5. The device of claim 1 wherein said main body can be folded for storage.

6. The device of claim 5 wherein said loop includes sliding buckles.

7. A method of securing items while using a wheelbarrow, the wheelbarrow having opposing, elongated handles and a load bed, the method comprising the steps of:
providing an enclosure having an opening and a number of straps extending therefrom, said straps adjustably connected to said handles to raise said enclosure relative to said handles to reduce sagging of said enclosure;
positioning said enclosure adjacent said load bed and between said handles;
securing said items within said enclosure;
adjusting said straps to position said enclosure relative to said handles.
